(19) United States
(12) Patent Application Publication
(10) Pub. No.: US 2010/0321021 A1
(43) Pub. Date: Dec. 23, 2010

(54) Metal detection excavation apparatus and method

(76) Inventor: Jack Alexander Siegel, Seminole, FL (US)

Correspondence Address: Jack Alexander Siegel, 7825 Ridge Road, Seminole, FL, 33772, US

(21) Appl. No.: 12/803,158

(22) Filed: Jun. 21, 2010

Related U.S. Application Data
(60) Provisional application No. 61/269,340, filed on Jun. 23, 2009.

(51) Int. Cl. B07B 1/02; A01B 1/02; G01V 3/10; B25B 23/18; G08B 21/00

(52) U.S. Cl. 324/329; 209/418; 362/119; 340/686.6

(57) ABSTRACT

An excavation apparatus for locating and separating an object from a medium comprising a handle, an excavation tool, a metal detector circuit, at least one coil connected to the metal detector circuit, and at least one output signal device connected to the metal detector circuit. The handle and the excavation tool share a unitary structure. The metal detector circuit is disposed within the handle, and has the at least one coil disposed inside of the excavation tool configured to produce a search field around the excavation tool from within the excavation tool, and the metal detector circuit is configured to notify user with the at least one output signal device when a metallic object is in proximity of the search field.

### BACKGROUND OF THE INVENTION

Metal Detectors came into use in the 1930s. This has been a popular hobby for many persons as well as a professional need for locating objects for scientific research or otherwise. As the methodology of metal detectors has evolved, one may use a hand held pin pointer detector to help to locate an object once it has been located by the use of a large metal detector. Shovels and trowels have also been designed and made for the purpose of digging up large and small objects after finding them with the large detectors. Both the shovel and pin-pointer are used to find desired objects in the ground, or other mediums. The shovel may be used to dig up the medium while the pin pointer may be used to locate the metallic object in the medium.

Different scoops have evolved which may be used for scooping to try to locate metallic objects. Many include the use of sifters for letting, for example, sand, go through a sieve to leave other objects behind.

While these digging, scooping, and sifting devices permit one to dig, scoop, and sift through the various mediums, the process is quite tedious. Treasure hunters may hold the shovel or scoop in one hand and a pin pointer in another hand to excavate and locate at the same time. Obviously, this is quite awkward and physically demanding upon the user.

Present day metal detectors have features such as discrimination and depth perception which permits the metal detector to locate a metallic object and also determine its depth. Certain metal objects may be arbitrarily selected to not be detected such as say, iron, bottle caps, foil and other trash that is not collectible to a treasure hunter. It is very difficult to determine the exact location of a metallic object in the dirt or other mediums as it is dug up. There is a need for a device that will detect the metallic objects and also dig into the medium to thus extract the metallic objects as opposed to locating and then digging with a separate tool. There is a need for a device that has a larger search coil configured in a new way and a search field combined with a means for excavating and extracting metallic objects.

### SUMMARY

The present invention aims to solve at least one of these and other problems.

According to a preferred embodiment of the present invention, an excavation apparatus for locating and separating an object from a medium comprising a handle, an excavation tool, a metal detector circuit, at least one coil connected to the metal detector circuit, and at least one output signal device connected to the metal detector circuit, the handle and the excavation tool share a unitary structure, the metal detector circuit is disposed within the handle, and having the at least one coil disposed inside of the excavation tool configured to produce a search field around the excavation tool from within the excavation tool, and the metal detector circuit is configured to notify user with the at least one output signal device when a metallic object is in proximity of the search field.

In one aspect, the at least one coil is configured to conform to the general shape of the excavation tool.

According to another preferred embodiment, the excavation apparatus's excavation tool may be a trowel.

According to another preferred embodiment, the excavation apparatus's excavation tool may be a scoop.

In one aspect, the scoop may further have at least one hole threw the scoop configured to allow a medium to pass threw the at least one hole in the scoop and leave an object behind.

According to another preferred embodiment, the excavation apparatus's excavation tool may be a shovel.

In one aspect, the excavation apparatus further comprises a switch disposed on the handle.

I one aspect, the excavation apparatus with a switch disposed on the handle is configured to operablely control the metal detector circuit.

I one aspect, the excavation apparatus with a switch disposed on the handle further comprises an illumination device disposed on the excavation apparatus and is configured to illuminate the excavation tool and surrounding mediums and is connected to the switch and operable thereto.

I one aspect, the excavation apparatus with a switch disposed on the handle may be operablely connected to the at least one output signal device.

In one aspect, the excavation apparatus's at least one output signal device may be at least one indication light configured to notify the user with a visible notification.

In one aspect, the excavation apparatus's at least one output signal device may be an audible device configured to notify the user with an audible notification.

In one aspect, the excavation apparatus's at least one output signal device may be a vibration device configured to notify the user with a discernible vibration notification.

According to another preferred embodiment, the excavation apparatus may further comprise a selective switch disposed on the handle and connected to the at least one output signal device, where the selective switch is configured to selectively activate the at least one output signal device.

According to another preferred embodiment, the excavation apparatus with a switch, further comprises a selective switch disposed on the handle and connected to the at least one output signal device, where the selective switch is configured to selectively activate the at least one output signal device.

According to another preferred embodiment, the excavation apparatus further comprising a compartment for holding a battery and allowing access thereto.

According to another preferred embodiment, the excavation apparatus further comprising a tuner connected to the metal detector circuit, operable to adjust sensitivity of the search field.

According to another preferred embodiment, the excavation apparatus further comprising a port disposed on the handle and connected to at least one of the metal detector circuit and a battery.

The present invention teaches a method of locating and separating an object from a medium comprising an excavation apparatus for locating and separating an object from a medium comprising a handle, an excavation tool, a metal detector circuit, at least one coil connected to the metal detector circuit, and at least one output signal device connected to the metal detector circuit.

The handle and the excavation tool share a unitary structure. The metal detector circuit is disposed within the handle, and has the at least one coil disposed inside of the excavation tool configured to produce a search field around the excavation tool from within the excavation tool, and the metal detector circuit is configured to notify user with the at least one output signal device when a metallic object is in proximity of the search field. The method includes the steps of energizing the metal detector circuit. Then scanning a medium with the excavation apparatus by holding the handle and waving the excavation tool over the medium. Once a notification signal is discerned from the at least one notification signal device, the user then excavates the object while using the at least one output signal devices to aid in excavation. After the object has been discovered the user then retrieves the object. Then turns off metal detector circuit and end search.

The device may be used in cooperative use with a full sized metal detector used when standing or may be used individually to locate and dig or scoop as a single use device.

One of the problems with prior art directly relate to were the coil is placed on the apparatus and how it is configured. By encasing the coil(s) inside of the excavation tool of the excavation apparatus, and further configuring the coil(s) to conform to the general shape of the excavation tool, creates an advantage over prior art by making it easier to locate and excavate an object from a medium.

### BRIEF DESCRIPTION OF THE DRAWINGS

FIG. 1 is a perspective view of an excavation apparatus according to a preferred embodiment.

FIG. 2 is a plan view of FIG. 1.

FIG. 3 is a left side view of FIG. 1.

FIG. 4 is a plan view of FIG. 1 showing excavation tool 1 having a broken away section.

FIG. 5 is a cross section view taken along line 5-5 in FIG. 4.

FIG. 6 is an enlarged detail view taken from FIG. 5.

FIG. 7 is a plan view showing the handle 2 broken away.

FIG. 8 is a flow diagram of a method of a metal detection excavation apparatus according to the present invention.

FIG. 9 is a plan view according to a second embodiment of the present invention.

FIG. 10 is a right side view of a second embodiment with broken away section.

FIG. 11 is a perspective view of a third embodiment of the present invention.

FIG. 12 is a simple schematic showing possible connections.

Index of Figures:
1. Excavation Tool
2. Handle
3. At least one Coil
4. Illumination Device
5. Battery
6. Metal Detector Circuit
7. Switch
8A. Indication light
8B. Indication light
9. Port
10. Compartment
11. Tuner
12. Audible Device
13. Excavation Apparatus
14. Vibration Device
15. Selective Switch
16. Search Field

### DETAILED DESCRIPTION OF PREFERRED EMBODIMENTS

Before explaining the present invention in detail, it should be understood that the present invention is not limited in its application or construction to the details of the arrangement of parts and construction illustrated in the accompanying drawings, because the present invention is capable of other embodiments and modifications and of being practiced or carried out in various ways. Furthermore; it should also be understood that the phraseology or terminology employed herein is for the purpose of description and illustration only, and not of limitation or restriction.

FIG. 1 discloses a perspective view of a preferred embodiment of a metal detection excavation apparatus 13 according to the present invention. Excavation tool 1 and handle 2 are made of a material which is non-detectable by a metal detector. In a preferred embodiment, excavation tool 1 and handle 2 share a unitary structure and may be formed of a composite plastic material but not limited to. Excavation tool 1 and handle 2 may be made separately and connected together to form a single unitary structure or made together as a single unitary structure. A cast may be made from a prototype and used to make a mold of the housing, once a mold has been made, the components may be disposed inside of the excavation apparatus 13 then sealed by heat, screws, or other means of sealing. If made in two parts, one way of manufacture may be dipping the at least one coil 3 in a liquid plastic cast and letting it harden and cure there by encasing at least one coil inside of excavation tool 1, but not limited to this method of manufacture. The material of which metal detection excavation apparatus 13 is comprised of may be sealed in such a way to be resistant to liquid and other mediums.

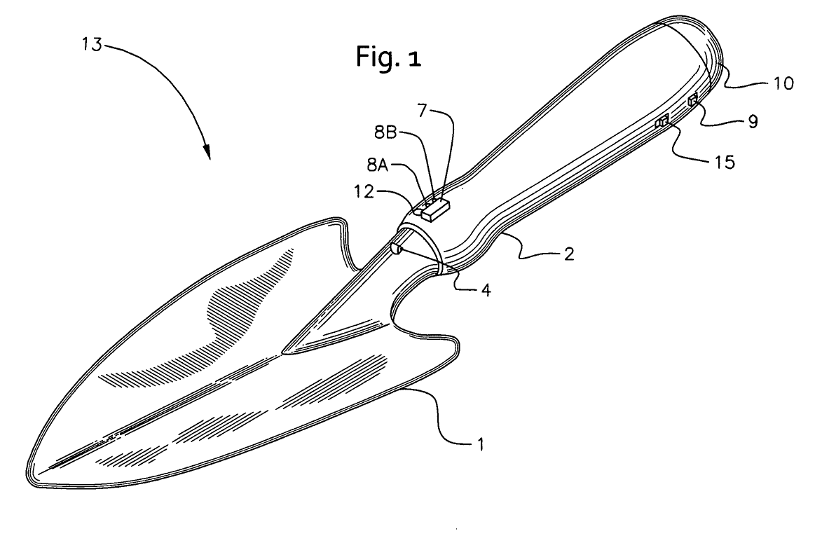

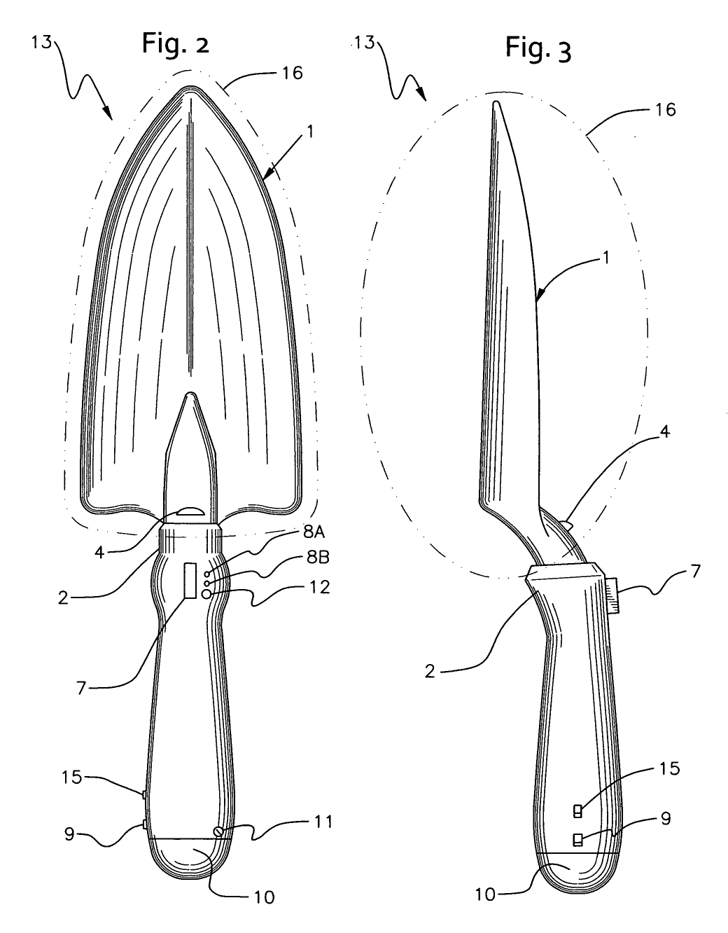

FIG. 2 is a plan view of FIG. 1 according to a preferred embodiment, and FIG. 3 is a left side view of FIG. 2.

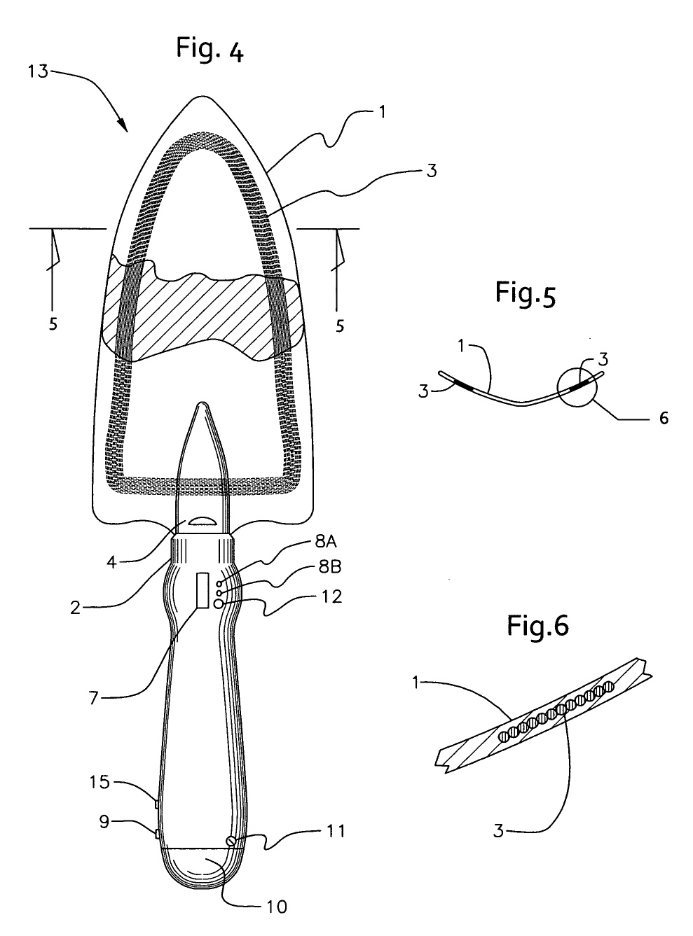

Referring now to FIG. 4, metal detection excavation apparatus 13 has at least one coil 3 encased in excavation tool 1. By way of example and not limitation, excavation tool 1 may be a trowel, spade, or scoop, but is not limited to these sizes or shapes. Metal detection excavation apparatus 13 may also be a full sized digging shovel.

At least one coil 3 may be one transmitting coil and one receiving coil configured to be used in a VLF, or very low frequency circuit. Other methods including BFO or Beat-frequency oscillator and Pulse indication may be used, as well as other metal detecting circuitries available but not limited to. DD shaped coils may also be used as at least one coil 3 in excavation tool 1 of metal detection excavation apparatus 13, as well as other coil configurations.

At least one coil 3 may be configured to conform to the general shape of excavation tool 1. At least one coil 3 may be a copper wire and may be wound or bent until the at least one coil 3 is configured to conform to the general shape of excavation tool 1 and may there by creating a search field 16 around excavation tool 1 similar to the general shape of excavation tool 1 as illustrated in FIG. 1 and FIG. 2. At least one coil 3 may be wound into any shape and disposed in excavation tool 1.

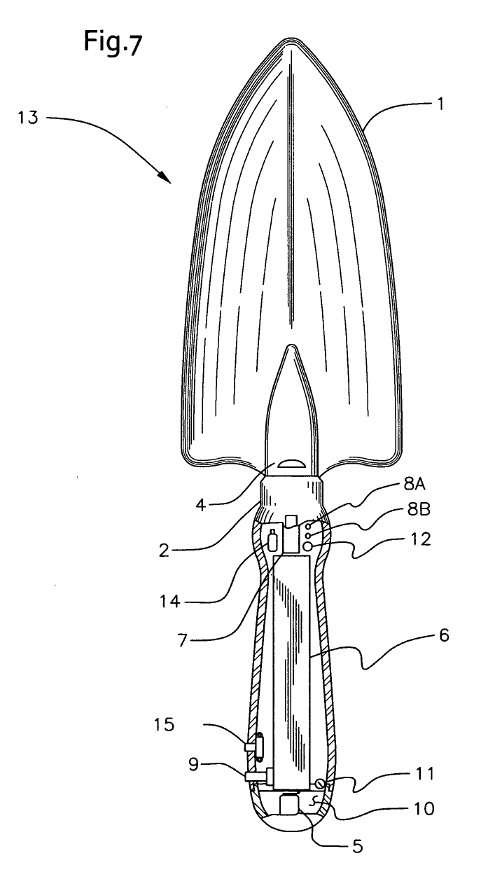

FIG. 5 discloses a cross section view taken along line 5-5 of FIG. 4. And FIG. 6 is an enlarged detail view of at least one coil 3 encased inside of excavation tool 1.

Referring now to FIG. 7, metal detector circuit 6 is available and used in other metal detection devices. In a preferred embodiment, metal detector circuit 6 may be disposed in or attached to handle 2.

Metal detector circuit 6 may be connected to at least one coil 3 of FIG. 4 by attaching the ends of at least one coil 3 directly to the metal detector circuit 6. This may also be accomplished by a second set of wires attached between metal detector circuit 6 and at least one coil 3, or other means, but not limited to. At least one coil 3 connected to metal detector circuit 6 may be configured to create a search field 16 around at least one coil 3 and excavation tool 1.

Referring to FIG. 3, in this embodiment search field 16 is configured to create its most sensitive areas over the top and bottom of the excavation tool 1. In FIG. 2 search field 16 is illustrated to show a less sensitive field around the sides of this embodiment.

Referring back now to FIG. 7, metal detector circuit 6 may be operablely controlled by switch 7 which may be disposed on handle 2 of metal detection excavation apparatus 13. Switch 7 may be a momentary switch, slide switch, tact switch, rocker switch, toggle switch, flip switch, or any other kind of switch, to activate metal detector circuit 6 on or off and may also selectively activate operable illumination device 4 on or off. Switch 7 may also be operable to selectively activate output signal devices 8B, 12, 14 on or off with the ability to select any or all output signal devices 8B, 12, 14 disposed in or on metal detection excavation apparatus 13 independently, simultaneously, or in any combination as the user chooses.

In FIG. 7, Illumination device 4 may be disposed anywhere on metal detection excavation apparatus 13, and may be connected to metal detector circuit 6, switch 7, battery 5 or Port 9, or any combination of these, but not limited to. The preferred embodiment would place illumination device 4 in metal detection excavation apparatus 13 between handle 2 and excavation tool 1 to illuminate surface of excavation tool 1, and surrounding areas of medium of which being excavated. Preferred method of illumination would be a Light-emitting diode, but not limited to. At least one light-emitting diode may be used to perform desired function, but more may be added. Incandescent light bulbs may also be used but not limited to. Switch 7 may also control illumination device 4 simultaneously or independently of metal detector circuit 6.

In FIG. 7, selective switch 15 may be connected to output signal devices 8B, 12, 14 to let user selectively activate which output signal devices 8B, 12, 14 the user wants to aid them in their search, independently or in any combination. Selective switch 15 may be a momentary switch, slide switch, tact switch, rocker switch, toggle switch, flip switch, or any other kind of switch.

In FIG. 7, Indication light 8A may indicate on/off power to metal detector circuit 6. Indication light 8B may indicate status of detection as at least one output signal device, which output signal devices 8B, 12, 14 selected, and may also indicate on/off power to illumination device 4. The ‘status of detection’ may refer to metal detector circuit 6 detecting a metallic object in search field 16 of at least one coil 3 encased in excavation tool 1 as illustrated in FIG. 2 and FIG. 3. When this happens, indication light 8B may turn on while a metallic object is in search field 16 of at least one coil 3 and turns off when a metallic object leaves search field 16 of at least one coil 3. Indication light 8B may be of any color and may have a separate color for each corresponding device disposed in or attached to metal detection excavation apparatus 13.

Referring back to FIG. 7, audible device 12 may be disposed in or on handle 2, which may be connected to metal detector circuit 6 and configured as at least one output device. This may indicate status of detection by making an audible notification noise or sound which may notify user desired object is being detected in search field 16. Audible device 12 may be controlled by selective switch 15 to function simultaneously or independently of other output devices 8B, 14 independently or in any combination. Audible device 12 may sound in a short beep or beeps or continually until desired metallic object leaves search field 16 of at least one coil 3. Metal detector circuit 6 may be configured to change frequency of noise or sound of audible device 12 as metallic object being excavated comes closer or farther from search field 16.

Vibration device 14 may be encased in handle 2 which may be connected to metal detector circuit 6, and configured to act as status of detection as at least one output signal device. This may indicate status of detection by making a discernible vibration which may notify user desired object is being detected. Vibration device 14 may be controlled by selective switch 15 to function simultaneously, independently, or in any combination of other output devices 8B, 12. Vibration device 14 may vibrate once or continually until desired metallic object leaves search field 16 of at least one coil 3. Metal detector circuit 6 may be configured to change strength of discernible vibrations of vibration device 14 as metallic object being excavated comes closer or farther from search field 16.

Metal detection excavation apparatus 13, may have at least one battery 5 which may be encased in compartment 10 of handle 2. Battery 5 may be a primary battery, this would be sufficient, however a secondary battery for example, a Lithium-ion and other forms of rechargeable battery would be preferred. Battery 5 may be connected to port 9 so that battery 5 may be charged threw port 9 with a power adaptor (not pictured) without the user having to remove battery 5.

Port 9 may be encased in handle 2 of metal detection excavation apparatus 13. Port 9 may have a plug (not pictured) made of a hard or preferably flexible material such as rubber attached to handle 2 which fits into port 9. This functions to substantially keep dirt, liquid, and other mediums from entering and corroding metal detector circuit 6 and other components encased in handle 2. Port 9 may be connected to metal detector circuit 6 and or battery 5 and may power metal detector circuit 6 without use of battery 5 when a power adaptor (not pictured) is attached.

Compartment 10 of metal detection excavation apparatus 13 may allow access to battery 5. Compartment 10 may also allow access to metal detector circuit 6, and other components disposed in handle 2. Compartment 10 may be accessed by having a screw top or by unscrewing a screw or a pinch opening, but not limited to.

Tuner 11 may be a knob or screw connected to metal detector circuit 6. This allows user to adjust sensitivity of metal detector circuit 6.

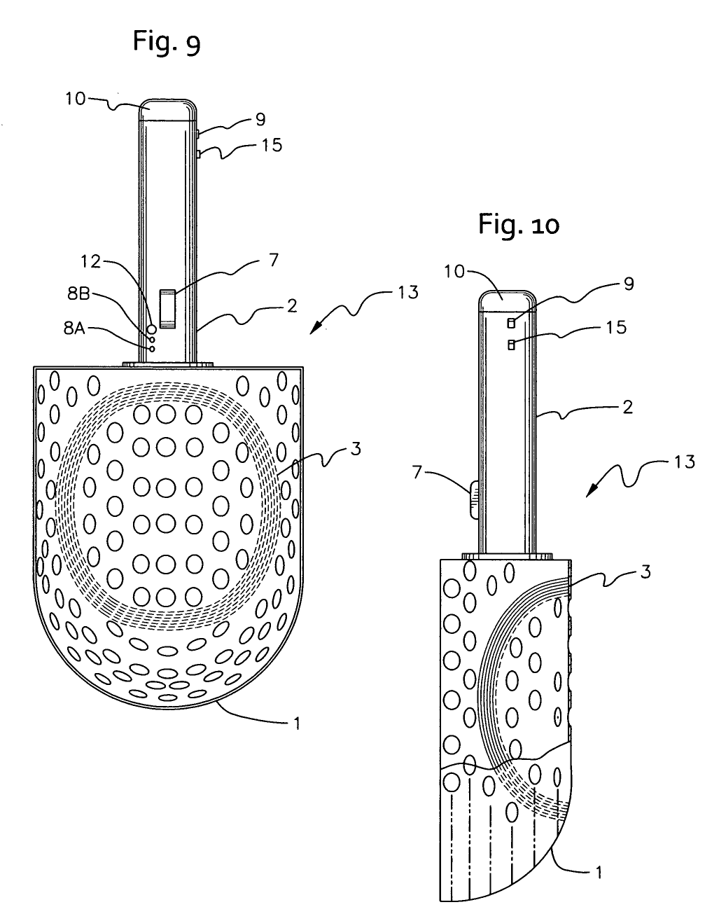

FIG. 9 discloses a second alternative embodiment wherein excavation tool 1 is a scoop with the ability to sift threw a medium. The scoop may have at least one hole threw it to allow a medium to pass threw the scoop and leave desired object inside the scoop. At least one hole may be of any shape and size. In FIG. 10, a side view of FIG. 9 is illustrated with a broken away section of excavation tool 1.

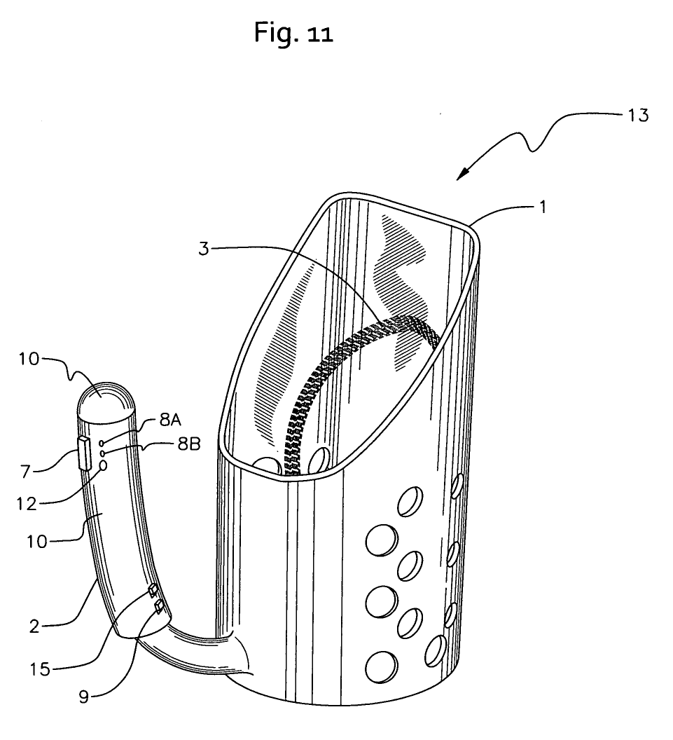

FIG. 11 discloses a third alternative embodiment wherein excavation tool 1 is a scoop similar to the scoop in FIG. 9 but differs in excavation tool 1 shape and handle 2 position on excavation apparatus 13.

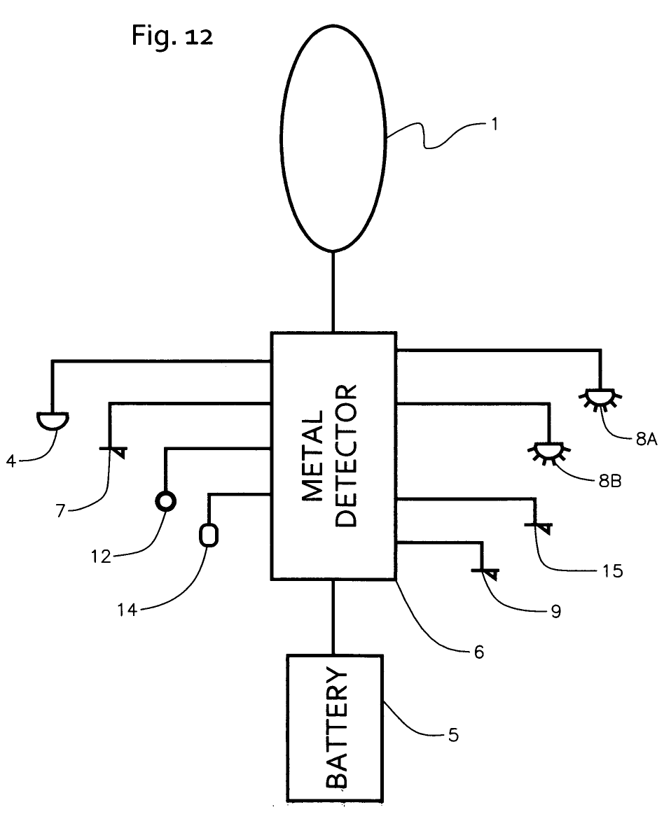

FIG. 12 discloses one possible simple schematic of the present invention.

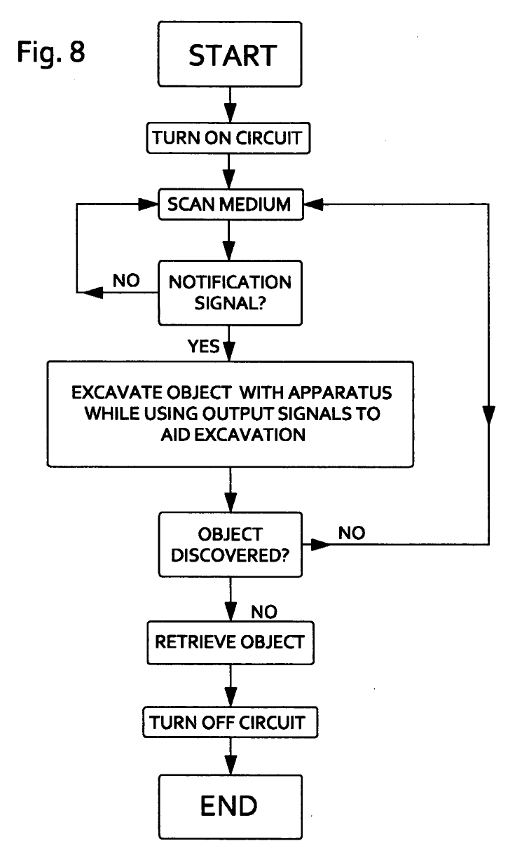

FIG. 8 discloses a flow diagram for a method of locating and separating an object from a medium using the present invention.

In this method, the user may start by turning on metal detector circuit 6 of metal detection excavation apparatus 13 with switch 7. The user then may scan medium of which being excavated by holding handle 2 of metal detection excavation apparatus 13 and waving excavation tool 1 over the medium. The user may wait for a notification from one of the at least one output signal devices 8B, 12, 14, signaling that a metallic object is being detected. If the user does not discern a notification from at least one out, the user may continue scanning until a notification is discerned.

Once a notification signal is discerned, the user may excavate the desired metallic object while using the at least one output signal devices 8B, 12,14 to aid in search and to further locate desired metallic object by notifying the user when excavation tool 1 is getting closer to desired metallic object as user is holding metal detection excavation apparatus 13 in anyway useful to them. This may include holding the metal detection excavation apparatus 13 sideways and running it along the medium or holding the metal detection excavation apparatus 13 pointed down and running it threw the dug up portion of the medium or the hole of the medium of which being excavated in search of the desired metallic object.

If the desired object is not yet discovered, the user may go back to scanning the medium until a notification signal 8B, 12, 14 discerns them. The user may begin to excavate desired object again while using the at least one notification signal devices 8B, 12, 14 to aid in users search.

Once object or objects have has been discovered, the user may turn off metal detector circuit 6 and end their search.

I claim:

1. An excavation apparatus for locating and separating an object from a medium comprising:
a handle;
an excavation tool;
a metal detector circuit;
at least one coil connected to said metal detector circuit; and
at least one output signal device connected to said metal detector circuit,
wherein said handle and said excavation tool sharing a unitary structure,
wherein said metal detector circuit is disposed within said handle, and having said at least one coil disposed inside of said excavation tool configured to produce a search field around said excavation tool from within said excavation tool, and said metal detector circuit is configured to notify user with said at least one output signal device when a metallic object is in proximity of said search field.

2. The excavation apparatus as claimed in claim 1, wherein said at least one coil is configured to conform to the general shape of said excavation tool.

3. The excavation apparatus as claimed in claim 1, wherein said excavation tool is a trowel.

4. The excavation apparatus as claimed in claim 1, wherein said excavation tool is a scoop.

5. The excavation apparatus as claimed in claim 4, further having at least one hole threw said scoop configured to allow a medium to pass threw said at least one hole in said scoop and leave said object behind.

6. The excavation apparatus as claimed in claim 1, wherein said excavation tool is a shovel.

7. The excavation apparatus as claimed in claim 1, further comprising:
a switch disposed on said handle.

8. The excavation apparatus as claimed in claim 7, wherein said switch is configured to operablely control said metal detector circuit.

9. The excavation apparatus as claimed in claim 7, further comprising:
an illumination device disposed on said excavation apparatus configured to illuminate said excavation tool and surrounding mediums and is connected to said switch and operable thereto.

10. The excavation apparatus as claimed in claim 7, wherein said switch is operablely connected to said at least one output signal device.

11. The excavation apparatus as claimed in claim 1, wherein said at least one output signal device is at least one indication light configured to notify the user with a visible notification.

12. The excavation apparatus as claimed in claim 1, wherein said at least one output signal device is an audible device configured to notify the user with an audible notification.

13. The excavation apparatus as claimed in claim 1, wherein said at least one output signal device is a vibration device configured to notify the user with a discernible vibration notification.

14. The excavation apparatus as claimed in claim 1, further comprising:
a selective switch disposed on said handle and connected to said at least one output signal device, wherein said selective switch is configured to selectively activate said at least one output signal device.

15. The excavation apparatus as claimed in claim 8, further comprising:
a selective switch disposed on said handle and connected to said at least one output signal device, wherein said selective switch is configured to selectively activate said at least one output signal device.

16. The excavation apparatus as claimed in claim 1, further comprising:
a compartment for holding a battery and allowing access thereto.

17. The apparatus claimed in claim 1, further comprising:
a tuner connected to said metal detector circuit, operable to adjust sensitivity of said search field.

18. The apparatus claimed in claim 1, further comprising:
a port disposed on said handle and connected to at least one of said metal detector circuit and a battery.

19. An excavation apparatus for locating and separating an object from a medium comprising:
a handle;
an excavation tool;
a metal detector circuit;
at least one coil connected to said metal detector circuit; and
at least one audible device connected to said metal detector circuit,
wherein said handle and said excavation tool sharing a unitary structure,
wherein said metal detector circuit is disposed within said handle, and having said at least one coil disposed inside of said excavation tool configured to conform to the general shape of said excavation tool and configured to produce a search field around said excavation tool from within said excavation tool, and said metal detector circuit is configured to notify user with said at least one audible device when a metallic object is in proximity of said search field.

20. A method for locating and separating an object from a medium comprising:
providing the excavation apparatus as claimed in claim 1, with steps of:
energizing said metal detector circuit;
scanning a medium with said excavation apparatus by holding said handle and waving said excavation tool over said medium.
a notification signal being discerned from said at least one notification signal device;
Excavate said object while using said at least one output signal devices to aid in excavation.
discovering said object;
retrieving said object;
turn off said metal detector circuit,
end search.
